(19) United States
(12) Patent Application Publication
(10) Pub. No.: US 2017/0005609 A1
(43) Pub. Date: Jan. 5, 2017

(54) SOLAR OPERATED DOMESTIC WATER HEATING SYSTEM

(71) Applicant: Benjamin MORENO, Omer (IL)

(72) Inventor: Benjamin MORENO, Omer (IL)

(21) Appl. No.: 15/125,735

(22) PCT Filed: Mar. 15, 2015
(86) PCT No.: PCT/IL2015/050271

§ 371 Date: Sep. 13, 2016

(30) Foreign Application Priority Data
Mar. 20, 2014 (IL) 231646

(51) Int. Cl. H02S 10/30; H02S 40/34; F24H 1/20; H02S 40/32

(52) U.S. Cl. CPC H02S 10/30; H02S 40/32; H02S 40/34; F24H 1/202; F24H 2240/09

(57) ABSTRACT

The invention relates to a solar water heating system which comprises: (a) a photovoltaic array for converting sun radiation to DC voltage; (b) a water tank which comprises a single heating element; and (c) a connection box receiving a first input from said photovoltaic array, and a second input from an AC residential supply, and outputting a combined voltage to said single heating element at the water tank, wherein said combined output voltage is a combination of one or more of—(i) a full rectified signal resulting from said AC residential supply passing through a full rectification semi-conductor element; and (ii) a DC voltage resulting from said DC voltage from the photo voltaic array passing through a unidirectional semi-conductor element.

### FIELD OF INVENTION

The field of the invention relates in general to electrical home appliances. More particularly, the invention relates to an improved solar operated domestic water heating system, which combines solar energy with energy from the AC residential supply.

### BACKGROUND OF THE INVENTION

Hot water is an essential commodity in the modern world, and a water heating system is an appliance which is widely used in households throughout the world.

In some countries where the price of the energy is negligible, it is common to operate the water heating system throughout the entire day, resulting in a significant waste of energy.

In countries where the cost of energy is relatively high, solar energy is typically used for heating the water. However, solar energy generally cannot provide hot water 24 hours a day, 365 days a year, therefore complementary heating which involves consumption of energy (such as electricity or gas) is required. In order to not to waste energy, the activation of said complementary heating is performed only at times of necessity.

The most common solar system for heating water comprises a main water tank which is associated next to a solar collector. The solar collector typically comprises a top solar plate which covers a network of small diameter water pipes. The solar plate collects heat from the sun, which in turn causes heating the said small diameter pipes. The heated water in said pipes is conveyed to the main tank, while cold water from the tank replaces said hot water within the small diameter pipes in the solar collector. Such water circulation continues throughout the day, as long as sun radiation exists. Hereinafter, the term “solar collector” will be referred only to said structure where water flows within small diameter pipe. This is in distinction to “photovoltaic arrays” that produce voltage, which is in turn used to supply electrical energy a heating element within the water tank. Furthermore, said most common type of solar water heating system which uses solar collectors will be referred to as “direct heating systems”, as in such systems the sun heats substantially directly the water within the pipes under the solar plate, and there is no conversion of energy type as is done in the photovoltaic cells (i.e., from heat to voltage, and from voltage to heat within the water tank).

It should be noted that significant losses in water heating systems occur at the pipes that lead water from the main tank which is located at the roof of the building to the consumer tap (these losses are more significant at cold weathers). In view of this situation, direct heating systems have been found efficient and are widely used mostly at locations (houses or apartment buildings) where the distance from the main tank (which is typically positioned at the roof of a house or building respectively) to the consumer tap is short. In tall buildings, where the length of the pipes may reach many tens of meters, the direct heating system is less efficient, or is used to supply hot water at most to the upper 3 to 4 floors. Those floors that are lower than said 3 to 4 top floors at the building typically do not enjoy from solar heated water in view of said substantial losses along the pipes. For those lower floor apartments, it is common to allocate an electricity heated main tank at a crawl space within each apartment. In such a manner, the distance to the water taps in each apartment is relatively short, resulting in relatively reasonable energy losses. However, as a result of the above situation, energy from solar collectors is typically not used at said lower floor apartments, only electricity or gas are used as a source of energy.

Photo-voltaic arrays are commonly used on roofs of buildings to convert sun radiation to electricity. The DC voltage which is created by the solar plates is converted to AC voltage, which in turn feeds the main electricity network.

There are additional disadvantages to the positioning of a water tank at the roof of a house or building, compared to positioning it at a crawl base. The roof is generally an open space which is exposed to environmental conditions, such as winds and low temperatures. Such conditions are particularly severe during the winter, and more so in roofs of tall buildings, where sometimes the water in the tank freezes. For example, if the water in a tank which is located at a roof (which is exposed to winds) is 60° at 18:00, a cold night may cause the water temperature to fall to 40° at 07:00 in the next morning. In contrary, the 60° water temperature in a water tank which is located at a crawl base will fall only to about 55° in the next morning.

Still an additional disadvantage of solar collectors relates to their reliability. Solar collectors that operate with water pipes suffer from corrosion, and needs replacement in average every 5-10 years. Photovoltaic arrays in comparison are more reliable and they need replacement every 20-25 years. Furthermore, the positioning of water tanks on a roof is unaesthetic. There are also countries in which a positioning of the water tank of the roof is not authorized.

U.S. Pat. No. 5,293,447 suggests a system for heating water using solar energy, which comprises a variable resistive load, and a controller for varying either the load characteristics of the resistive load, or the power generating characteristics of the photo-voltaic array, or both. This publication, however, suggests use of at least two separate heating elements, a first heating element 20 which is connected to a solar photovoltaic array, and a second heating element 28 which is connected to the residential main AC supply. The heating element 20, in itself may comprise plurality of elements. The system of U.S. Pat. No. 5,293,447 further comprises a controller for selecting, each time another combination of resistive elements within element 20, in order to optimize the power efficiency as obtained from the solar array. However, this arrangement is in practice not applicable for the modification of those existing heating systems that are only electrically operated (and which typically include a single heating element at each water tank) to operate with solar energy (as well as with complementary energy from the AC main power).

CN102444976 discloses a solar water heating system for use in apartment buildings. This publication, in similarity with U.S. Pat. No. 5,293,447, suggests use of two separate heating elements, one for the DC supply from the photovoltaic array, and another from the AC residential supply.

It is an object of the present invention to provide an improved solar water heating system which is compatible with existing water tanks, not requiring any modification to the internal structure of the water tank.

It is still another object of the present invention to provide a water tank which is suitable for operation with photovoltaic arrays, and whose structure is simpler than of similar tanks for operation with photovoltaic arrays as provided by the prior art.

It is still another object of the present invention to provide a solar water heating system which improves the efficiency in comparison to existing solar systems.

It is still another object of the present invention to provide a solar water heating system which is suitable for use in lower floors as well as high floors of tall buildings, as well as in small houses.

It is still another object of the present invention to provide a system which simplifies the combined operation with both photo-voltaic arrays, as well as with the AC residential supply.

Other advantages of the present invention will become apparent as the description proceeds.

### SUMMARY OF THE INVENTION

The invention relates to a solar water heating system which comprises: (a) a photovoltaic array for converting sun radiation to DC voltage; (b) a water tank which comprises a single heating element; and (c) a connection box receiving a first input from said photovoltaic array, and a second input from an AC residential supply, and outputting a combined voltage to said single heating element at the water tank, wherein said combined output voltage is a combination of one or more of: (i) a full rectified signal resulting from said AC residential supply passing through a full rectification semi-conductor element; and (ii) a DC voltage resulting from said DC voltage from the photo voltaic array passing through a unidirectional semi-conductor element.

Preferably, said water tank is located at a crawl base within an apartment or house.

Preferably, said water tank further comprises a thermostat in series with said single heating element, and wherein said combined voltage is supplied to said single heating element via said thermostat.

### BRIEF DESCRIPTION OF THE DRAWINGS

In the drawings:

FIG. 1 shows a general structure of a prior art water tank which is adapted to operate with a solar collector;

FIG. 1A shows a general structure of a water tank as preferably used in the system of the present invention;

FIG. 2 shows a general structure of a solar water heating system according to an embodiment of the present invention;

FIG. 3 shows a structure of a connection box which combines a first input from a solar array and a second input from the AC residential supply, and outputs a combined voltage to a single heating element at the water tank;

FIG. 4 illustrates a manner of combination of a full rectified AC supply and a DC voltage, as performed by the connection box of the invention; and

FIG. 5 shows a typical distribution of the voltage level, as provided from a solar array, during a typical day.

### DETAILED DESCRIPTION OF PREFERRED EMBODIMENTS

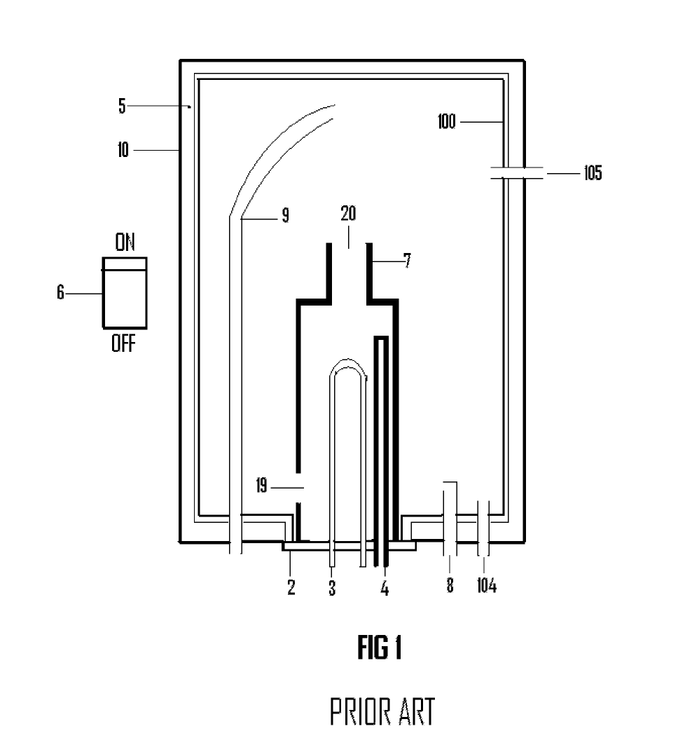

FIG. 1 shows a hot water tank commonly used in systems of the prior art. The water tank 100 comprises an electric heating element 3 for heating the water. Heating element 3 is essentially a resistor, which is heated by an electric current flowing through it, and transferring heat to the surrounding water. The water tank further comprises in its lower part an inlet water-pipe 8, and in its upper part an outlet water-pipe 9. A metal flange 2 at the bottom of the tank supports the heating element 3. Also supported by the flange is a metal sleeve 4, serving as a pocket for a standard thermostat. The water tank 100 further comprises a heat concentrator 7. The heat concentrator 7, which is preferably used in a vertically oriented tank, is a cup-like device made of any suitable material, and mechanically connected to the bottom of the water tank. The heat concentrator 7 has an inlet opening 19 at its lower part, and an outlet opening 20 at its top. The heat concentrator 7 encloses the heating element 3 and the thermostat casing 4, in which a thermostat (not shown) is positioned. When the heating element 3 is activated, hot water in concentrator 7 flows to the top opening 20, and cold water flows through the lower openings 19 to the concentrator, creating water circulation. Layers of hot water are therefore concentrated at the upper part of the water tank. After a long period of heating, all the water in the tank becomes hot, and the water temperature in different parts of the tank is relatively homogeneous. Generally, it is common to use a heat concentrator 7 in water tanks of 80 liters or more. Insulating layer 5 prevents heat transfer to the surroundings. Thin metal 10 encloses the tank and the insulating layer 5. Remote ON/OFF switch 6, is usually located in an easily accessed place, and generally comprises a red indication which lights when the switch is ON. When the switch is ON and the water temperature rises to the preset temperature of the thermostat, the thermostat disconnects current to element 3. When the water temperature falls below said preset temperature, the thermostat reconnects the current to the heating element. Commonly, when the tank is positioned on a roof of a house or building, a second outlet 104 at the bottom of the tank provides water to a solar collector, while heated water from the solar collector is returned via inlet 105 to the tank. As previously noted, in tall building this solution is applicable substantially only for the higher floors (typically at most the top three floors), in view of significant temperature losses from the hot water pipes to the surrounding. Moreover, as note before, a water tank which is positioned in a crawl base is much more efficient in terms of energy losses, as it is protected from sever whether conditions. Therefore, the art has suggested positioning of the water tank in said lower floors within a crawl base, and use of electricity for heating.

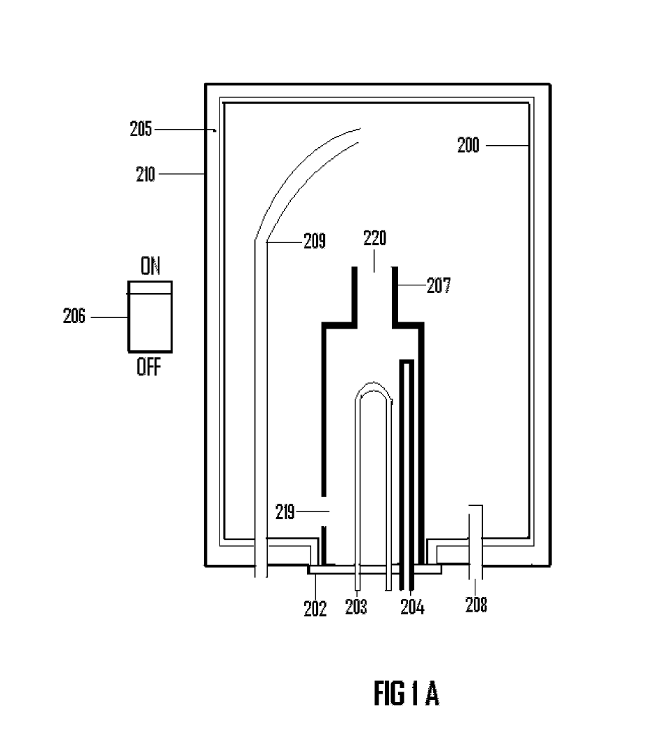

FIG. 2 illustrates the general structure of a water heating system 70 according to an embodiment of the present invention. As in the prior art, the system comprises a photovoltaic array 11 which is typically positioned at the roof of the house or building. Hereinafter, the description will refer to “building”. However, this is done only for the sake of convenience, as the invention is also applicable for use in houses, swimming pools, etc. The photovoltaic array 11 is connected by means of electric wires 12 to a first input of a connecting box 13, which is preferably located within or next to the apartment, or next to the water tank 200. The residential AC supply 21 is connected to a second input of the connecting box 13. An output 27 from the connection box is connected to a single heating element 203 (optionally via a thermostat) which is located within a water tank 200. As shown in FIG. 1A, the water tank 200 according to the invention is substantially identical in its structure to the water tank of FIG. 1, however, without the outlet 104 and inlet 105 to a solar collector which does not exist in the system of the present invention. Water tank 200 is preferably located at a crawl base (or another suitable location) within the apartment (although this is not mandatory, as the water tank may also be positioned at the roof of a building or house). Positioning of the water tank at a crawl base is particularly advantageous in apartments that are located at tall buildings, as such a location is protected from the outside tough environment (cold and winds), and is also very close to the tap of the consumer.

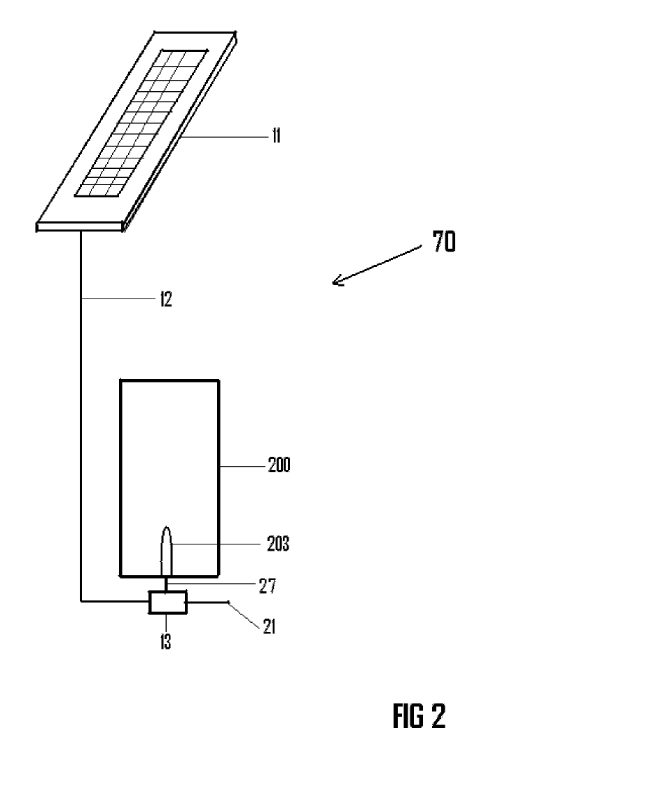

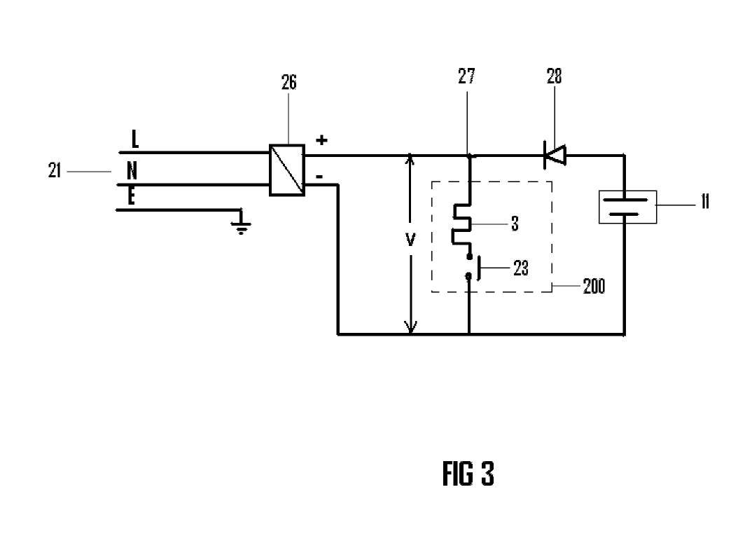

As noted above, the connection box 13 has two feed inputs (a first input 12 from the solar photovoltaic array 11, and a second input 17 from the residential AC supply), and a single output 21 to the heating element 203 (shown in FIG. 1A) of the water tank. The structure of the connection box 13 according to a first embodiment of the present invention is shown in FIG. 3. The residential AC supply is provided to the connection box via lines 21. This AC supply passes through a diode bridge 26, which creates a full rectified voltage 250 (shown in FIG. 4) at the output of the bridge (i.e., at common point 27 shown in FIG. 3). The DC voltage from the photovoltaic array 11, in turn passes through diode 28 to the same common point 27, creating DC voltage 260 as shown in FIG. 4. Therefore, and depending on the specific mode of operation, the voltage at point 27 (hereinafter, a “combined voltage”) is in fact either: (a) the fully rectified AC voltage 250 as provided from the AC residential supply (this mode is typical, for example, to night times when the photovoltaic array 11 is inactive, and the user activates the complementary AC supply to heat the water); (b) the DC supply 260 from array 11 (this mode is typical day times when the photovoltaic array is active); or (c) a combination of both said fully rectified voltage 250 and said DC voltage 260 (this mode is typical, for example, to winter day times, when the DC voltage from the photovoltaic array 11 exists, but is insufficient to heat the water to the desired temperature, therefore the user activates the AC main as a complementary supply). It should be noted that the use of the bridge 26 and of the diode 28 provide isolation of the two sources respectively, that prevents any leakage of AC voltage from the AC supply to the photovoltaic array 11, or vice versa, leakage of DC voltage from the photovoltaic array 11 to the residential AC supply. In any case, the energy losses over the bridge 26 and diode 28 are negligible, and this is a significant advantage of the invention, as the combination in fact involves no energy loss. It should be noted that the diode bridge 26 may in fact be any full rectification semi-conductor element or equivalent thereof, and the diode 28 may be any unidirectional semiconductor element or equivalent thereof. Furthermore, the full rectified voltage 250 may also be stabilized by an addition of a capacitor (not shown). It has been found by the inventor that the addition of the capacitor is not advantageous over the operation with a full rectified voltage, as it somewhat reduces the efficiency.

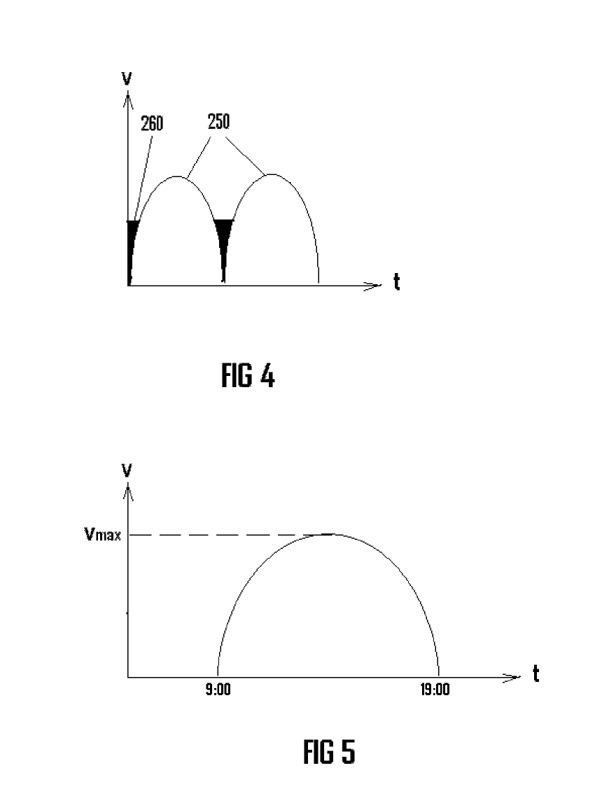

As is well known in the art, the DC supply 260 from the photovoltaic array 11 highly depends on the sun radiation. A typical distribution of a voltage level from a photovoltaic array relative to the hour of the day is shown in FIG. 5. This distribution directly affects the level of the DC voltage 260 from the array 11.

In any case, the voltage over the common point 27 is provided to the single heating element 203 within the water tank 200. Preferably, this voltage supply is done via thermostat 29, in the conventional manner.

As shown, the arrangement as described is very simple and efficient in its structure. This arrangement provides the “combined” voltage to a same single heating element 203 of the tank, a fact which enables use of the invention with existing water tanks, with no need for any internal modification, clearly with no need for replacement of the entire water tank for adaptation to the solar heating system of the invention. Moreover, the arrangement of the invention can be used to adapt existing water tanks that are located within crawl bases of lower floor apartments of tall buildings that are presently fed only from the main AC supply to operate also with solar energy. The system of the invention is also more reliable than comparable solar systems of the prior art, as it eliminates the solar collectors that are commonly used in the prior art, and is more efficient, as it eliminates the long water pipes as used in said prior art solar systems. Furthermore, the efficiency of the system is improved, as it enables positioning of the water tank within a crawl base at each apartment, a location which is not exposed to the open environment.

### EXAMPLE

Presently, a typical heating element in a domestic water heating tank has a value of about 21 Ohm. When fed from a 230V, the heating power is about 2500 Watts. A photovoltaic array having an area of between 1.5 m² and 4 m² can provide such power in a sunny day. Therefore, a significant electrical power can be saved by use of such a photovoltaic array. Moreover, as photovoltaic arrays are typically positioned in an orientation which is tilted against the sun, the effective area which is occupied is even less. Therefore, a typical roof of a tall building can easily contain at least several tens of such photovoltaic arrays. Each photovoltaic array should be connected to its respective connection box 13 via two wires. The water tank which is preferably located within a crawl base within each apartment, is protected from the open environment resulting in reduction of energy losses. Moreover, the pipe lines to water tap of the consumer are significantly shorter, resulting in additional save of energy.

As described above, the invention is useful in apartments of tall buildings. However, the invention is not limited for use in any particular location, and may similarly be used in private houses, swimming pools, public facilities, etc. It should also be noted that the diode and diode bridge mentioned above may be replaced by other equivalent unidirectional devices (either of the semi-conductor type or not) in a manner well known to those skilled in the art.

While some embodiments of the invention have been described by way of illustration, it will be apparent that the invention can be carried out with many modifications variations and adaptations, and with the use of numerous equivalents or alternative solutions that are within the scope of persons skilled in the art, without departing from the spirit of the invention or exceeding the scope of the claims

1. A solar water heating system which comprises:
a. a photovoltaic array for converting sun radiation to DC voltage;
b. a water tank which comprises a single heating element; and
c. a connection box receiving a first input from said photovoltaic array, and a second input from an AC residential supply, and outputting a combined voltage to said single heating element at the water tank, wherein said combined output voltage is a combination of one or more of:
(i) a full rectified signal resulting from said AC residential supply passing through a full rectification semi-conductor element; and
(ii) a DC voltage resulting from said DC voltage from the photo voltaic array passing through a unidirectional semi-conductor element.

2. A system according to claim 1, wherein said full rectification semi-conductor element is a diode bridge.

3. A system according to claim 1, wherein said unidirectional semi-conductor element is a diode.

4. A system according to claim 1, wherein said water tank is located at a crawl base within an apartment or house.

5. A system according to claim 1, wherein said water tank further comprises a thermostat in series with said single heating element, and wherein said combined voltage is supplied to said single heating element via said thermostat.
